(19) United States
(12) Patent Application Publication
(10) Pub. No.: US 2024/0128560 A1
(43) Pub. Date: Apr. 18, 2024

(54) POWER BATTERY TOP COVER STRUCTURE

(71) Applicant: NINGBO ZHENYU TECHNOLOGY CO.,LTD., Ningbo (CN)

(72) Inventors: Shiya He, Ningbo (CN); He Liang, Ningbo (CN); Hang Liu, Ningbo (CN)

(21) Appl. No.: 18/308,955

(22) Filed: Apr. 28, 2023

(30) Foreign Application Priority Data
Oct. 13, 2022 (CN) 202211250505.4
Oct. 13, 2022 (CN) 202211250857.X

(51) Int. Cl. H01M 50/172; H01M 50/16; H01M 50/184; H01M 50/186; H01M 50/566

(52) U.S. Cl. CPC H01M 50/172; H01M 50/16; H01M 50/184; H01M 50/186; H01M 50/566; H01M 50/627

(57) ABSTRACT

The disclosure provides a power battery top cover structure, comprising a top cover plate and a conductive terminal structure. The conductive terminal structure moves from bottom to top under an assembly hole so that a terminal body is assembled into the assembly hole, connecting portions of the conductive terminal structure are positioned in connecting grooves of the top cover plate, and the connecting portions are in contact with and welded with the connecting grooves, so that the conductive terminal structure is fixedly connected to the top cover plate. The independently manufactured and molded terminal structure is welded with the connecting hole of the top cover plate for fixing, which simplifies design and manufacturing process, thereby improving production efficiency and reducing production cost.

### TECHNICAL FIELD

The disclosure pertains to the technical field of manufacturing battery accessories for new energy vehicles, and specifically pertains to a power battery top cover structure.

### BACKGROUND

Power battery is an important component of new energy vehicles. The existing new energy vehicles mostly use lithium-ion batteries as power batteries. For power lithium batteries, in addition to key components such as battery cells and BMS, battery case structure is also an important safety factor. Among them, terminal is an integral part of a battery module. The traditional assembly method of the terminal comprises assembling the terminal into an assembly hole, and then forming a relative complex connection structure between the terminal and a top cover by welding, riveting or injection molding to fixedly connecting the terminal on the top cover. However, the process of forming a connection structure is relatively complicated, and material properties of the top cover need to be considered, which makes the design and manufacturing process of the battery top cover cumbersome, resulting in the problem of low efficiency and high production cost in manufacturing and molding of the battery top cover.

### SUMMARY

The object of the disclosure is to design a power battery top cover structure to solve the technical problems, and its specific implementation is as follows.

The power battery top cover structure of the disclosure comprises a top cover plate and a conductive terminal structure, and the conductive terminal structure is fitted in a terminal mounting position on the top cover plate;
the terminal mounting position comprises an assembly hole and connecting grooves arranged continuously or at intervals, the assembly hole is arranged on the top cover plate in a penetrating manner, and the connecting grooves are formed by recessing a portion of the top cover plate located at a bottom surface of the assembly hole inward, the connecting grooves are formed at an edge of a lower port of the assembly hole, and the connecting grooves are arranged in communication with the assembly hole;
connecting portions arranged continuously or at intervals are formed on a bottom peripheral wall of the conductive terminal structure, and the connecting portions are in a protruding state on the bottom peripheral wall of the conductive terminal structure; and
the conductive terminal structure moves from bottom to top under the assembly hole so that a terminal body is assembled into the assembly hole, the connecting portions are positioned in the connecting grooves, and an outer peripheral wall of the terminal body of the conductive terminal structure is arranged in contact with an inner peripheral wall of the assembly hole, and outer walls of the connecting portions are in contact with and welded with inner walls of the connecting grooves, so that the conductive terminal structure is fixedly connected to the top cover plate.

According to the power battery top cover structure, the conductive terminal structure comprises a terminal fixture, a terminal, a sealing ring and an insulator; the terminal fixture comprises a ring bottom and a ring wall formed on a top surface of the ring bottom; a terminal fixing cavity in communication with a positioning hole on the ring bottom is formed between the top surface of the ring bottom and the ring wall, and a position between an outer peripheral wall of the ring wall and an outer peripheral wall of the ring bottom forms the connecting portions; both the terminal and the sealing ring are placed in the terminal fixing cavity; a terminal fixing portion of the terminal is positioned in an inner hole of the sealing ring, an outer peripheral wall of the terminal fixing portion of the terminal is arranged in contact with an inner peripheral wall of the sealing ring, and the sealing ring is located between the terminal fixing portion of the terminal and an inner bottom surface of the terminal fixing cavity; the insulator is arranged to at least partially cover the terminal and is at least partially located between an outer peripheral wall of a terminal portion of the terminal and an inner peripheral wall of the ring wall; and the insulator and the terminal fixing portion of the terminal are arranged in concave-convex fit, an inner peripheral wall of the terminal fixing cavity and an outer peripheral wall of the insulator are arranged in concave-convex fit, and a first restricting portion on the ring wall is in fit with a second restricting portion on the insulator, so that the insulator, the sealing ring and the terminal are all fixedly connected in the terminal fixing cavity, and a top surface of the terminal portion of the terminal is higher than a top surface of the top cover plate and is exposed to the outside.

According to the power battery top cover structure, a concave cavity is formed on an inner wall of the insulator, convex portions arranged continuously or at intervals are formed on the terminal fixing portion of the terminal along a circumference of the outer peripheral wall of the terminal fixing portion, the convex portions are embedded in the concave cavity, positioning convexes are formed on an inner wall of the concave cavity, positioning concaves are formed on the convex portions, and the positioning convexes are correspondingly embedded in the positioning concaves.

According to the power battery top cover structure, a stepped surface is formed on the insulator, the stepped surface is the first restricting portion, and a riveting body is formed on a top of the insulator, and the riveting body is pressed on the stepped surface of the insulator, so that the terminal and the sealing ring are fixedly connected in the terminal fixing cavity of the terminal fixture; and the riveting body is the second restricting portion, and an outer peripheral wall of the terminal fixture is arranged in contact with the inner peripheral wall of the assembly hole.

According to the power battery top cover structure, the sealing ring comprises a sealing ring sheet and a sealing ring body formed on a bottom surface of the sealing ring sheet, an outer wall of the sealing ring body is in contact with an inner wall of the positioning hole on the ring bottom, the sealing ring sheet is located between the convex portions and the ring bottom in a compressed state, a convex ring is formed on the top surface of the ring bottom, a ring groove is formed on the bottom surface of the sealing ring sheet, and the convex ring is embedded in the ring groove; and the terminal fixing portion of the terminal is positioned in an inner hole of the sealing ring sheet, and the outer peripheral wall of the terminal fixing portion of the terminal is arranged in contact with an inner hole wall of the sealing ring sheet, so that the terminal fixing portion of the terminal and the ring bottom are sealed.

According to the power battery top cover structure, the power battery top cover structure further comprises a lower plastic part, the lower plastic part is fixed on a bottom surface of the top cover plate, and the top cover plate is provided with an electrolyte injection port and an explosion-proof valve; a through hole positionally corresponding to the positioning hole on the ring bottom, an electrolyte injection hole positionally corresponding to the electrolyte injection port and a vent hole positionally corresponding to the explosion-proof valve are formed on the lower plastic part; and an annular convex is formed by extending an upper port edge of the through hole upwards, and the annular convex is placed in the positioning hole on the ring bottom.

According to the power battery top cover structure, the insulator is preformed, or the insulator is formed by performing injection molding and encapsulation treatment on the terminal, and limiting portions are convexly formed on the outer peripheral wall of the insulator; a pressure is applied to the terminal, so that the ring wall is bent toward the terminal when the ring wall is in a compressed state to form the riveting body, and the riveting body is at least partially located above the convex portions; and the inner peripheral wall of the ring wall is recessed to form limiting grooves, and the limiting portions are fitted in the limiting grooves to radially limit the insulator and the terminal fixture.

According to the power battery top cover structure, a plurality of limiting grooves are formed on the ring wall; a pressure is applied to the terminal, so that the insulator is injection molded when the sealing ring is in the compressed state; the insulator comprises a terminal covering portion, a ring wall covering portion, a riveting body covering portion and the limiting portions fitted in the limiting grooves; a locking cavity is formed among an outer wall of the terminal covering portion, an inner wall of the ring wall covering portion and an inner wall of the riveting body covering portion; the outer wall of the terminal covering portion is recessed to form a fixing concave; an inner bottom surface of the fixing concave is used as the stepped surface, and the ring wall and the riveting body are embedded in the locking cavity; the riveting body is embedded in the fixing concave, so that the terminal covering portion is located between the terminal and the inner peripheral wall of the ring wall; the ring wall covering portion is covered on the outer peripheral wall of the ring wall, and the terminal portion of the terminal is at least partially covered by an inner peripheral wall of the terminal covering portion, and an outer peripheral wall of the ring wall covering portion is arranged in contact with the inner peripheral wall of the assembly hole; and the limiting portions are formed on the inner wall of the ring wall covering portion, and the concave cavity is formed on the inner peripheral wall of the terminal covering portion; and the terminal covering portion, the ring wall covering portion, the riveting body covering portion and the limiting portions are combined to form an integral insulator.

According to the power battery top cover structure described above, a plurality of recesses are formed on an inner wall of the terminal fixing cavity, a plurality of protrusions are formed on an outer wall of the insulator, and the protrusions are correspondingly embedded in the recesses.

According to the power battery top cover structure, a plurality of flanges are formed on the outer peripheral wall of the ring wall, a plurality of depressions are formed on the inner peripheral wall of the assembly hole, and the flanges are embedded in the depressions.

Compared with the prior art, the power battery top cover structure designed by the disclosure has the following beneficial effects:
1. The conductive terminal structure manufactured and molded independently is used, and the conductive terminal structure is welded with the assembly hole of the top cover plate via the connecting portions for fixing, thus realizing modular assembly of the battery top cover without considering material properties of the top cover plate (e.g., ductility), which simplifies design and manufacturing process of the battery top cover to improve manufacturing efficiency of the battery top cover and reduces manufacturing cost accordingly.
2. The convex ring is embedded in the ring groove, and the convex portions press the sealing ring sheet, which improves performance of sealing between the terminal and the ring bottom, so that the sealing performance of the injection molded terminal can meet the design requirements.
3. The convex portions are arranged in fit with the concave cavity, which prevents the terminal from playing up and down axially after the terminal is fixedly connected in the terminal fixing cavity.
4. A plurality of limiting grooves are formed on the terminal fixture, so that after the insulator is formed, the limiting portions of the insulator are located in the limiting grooves, so as to increase the torque and prevent relative rotation between the insulator and the terminal fixture, meet the product function and comply with the design requirements.
5. The positioning convexes are correspondingly embedded in the positioning concaves to increase the torque and prevent the relative rotation between the terminal and the insulator, which meets the product function and complies with the design requirements.
6. The riveting body is formed so as to prevent the terminal assembled into the terminal assembly cavity from falling off.

### BRIEF DESCRIPTION OF THE DRAWINGS

FIG. 1 is a schematic view of an assembly sequence of assembling a conductive terminal structure to a top cover plate (1);

FIG. 2 is a schematic view of the assembly sequence of assembling the conductive terminal structure to the top cover plate (2);

FIG. 3 is a schematic view of a top cover structure with the conductive terminal structure assembled to the top cover plate (1);

FIG. 4 is a schematic view of the top cover structure with the conductive terminal structure assembled to the top cover plate (2);

FIG. 5 is a stereoscopic view of the conductive terminal structure (1);

FIG. 6 is a stereoscopic view of the conductive terminal structure (2);

FIG. 7 is a sectional view of the conductive terminal structure (1);

FIG. 8 is a sectional view of the conductive terminal structure (2);

FIG. 9 is an exploded view of the conductive terminal structure (1);

FIG. 10 is an exploded view of the conductive terminal structure (2);

FIG. 11 is an exploded view of the conductive terminal structure (3);

FIG. 12 is an exploded view of the conductive terminal structure (4);

FIG. 13 is a schematic structural view of a terminal fixture;

FIG. 14 is a sectional view of an integral power battery top cover structure (1);

FIG. 15 is a sectional view of the integral power battery top cover structure (2);

FIG. 16 is a schematic structural view of a top surface of the integral power battery top cover structure (1);

FIG. 17 is an enlarged view of A;

FIG. 18 is a schematic structural view of the top surface of the integral power battery top cover structure (2);

FIG. 19 is a schematic structural view of a bottom structure of the integral power battery top cover structure (1);

FIG. 20 is a schematic structural view of the bottom surface of the integral power battery top cover structure (2);

FIG. 21 is a sectional view of a split power battery top cover structure (1);

FIG. 22 is a schematic structural view of a top surface of the split power battery top cover structure;

FIG. 23 is a schematic structural view of a bottom structure of the split power battery top cover structure;

FIG. 24 is a partial view of a top cover structure (1);

FIG. 25 is a partial view of the top cover structure (2); and

FIG. 26 is a sectional view of the top cover structure.

### DESCRIPTION OF THE EMBODIMENTS

The technical schemes of the embodiments of the disclosure will be described clearly and completely below with reference to the accompanying drawings in the embodiments of the disclosure, and it is obvious that the embodiments described are only some, instead of all, of the embodiments of the disclosure. All other embodiments obtained by those skilled in the art based on the embodiments of the disclosure fall within the scope of the disclosure.

### Embodiments

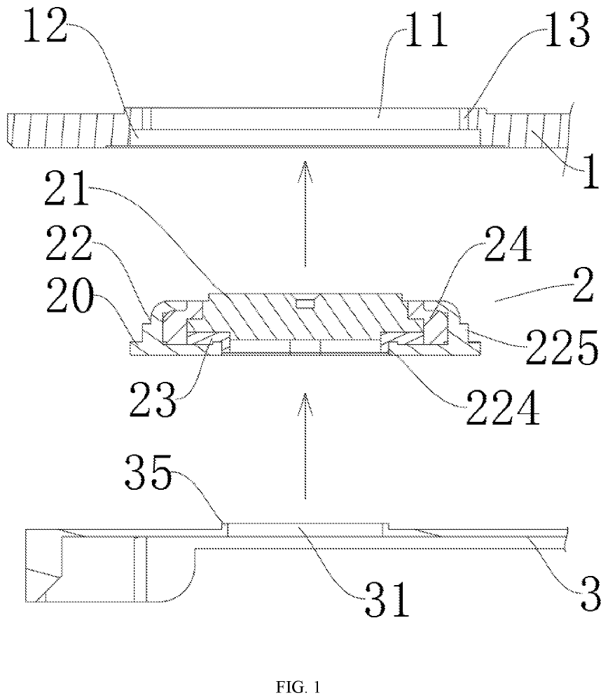

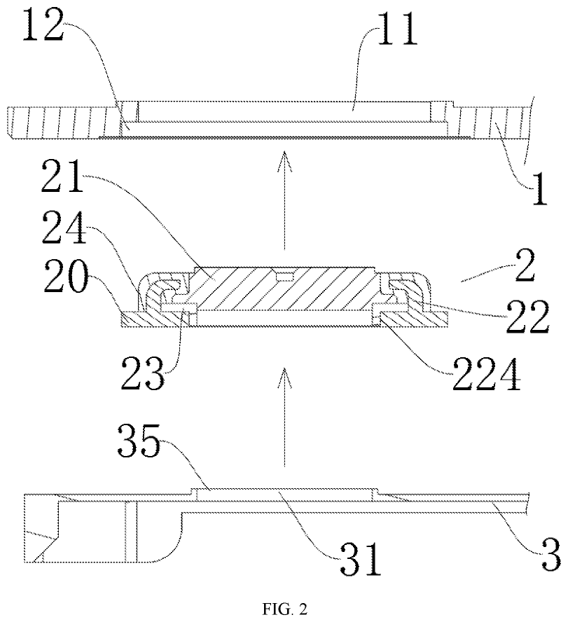

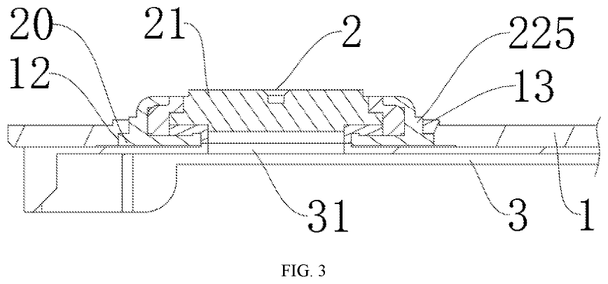

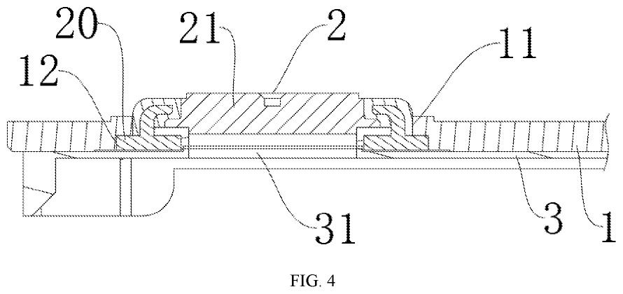

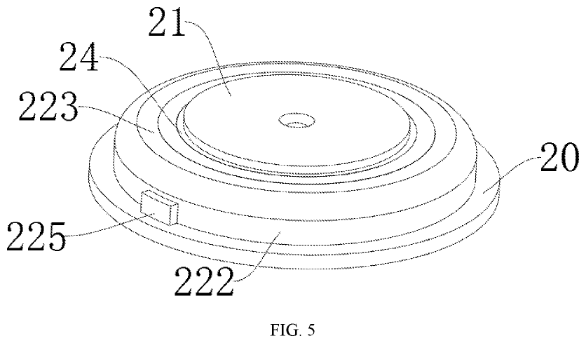

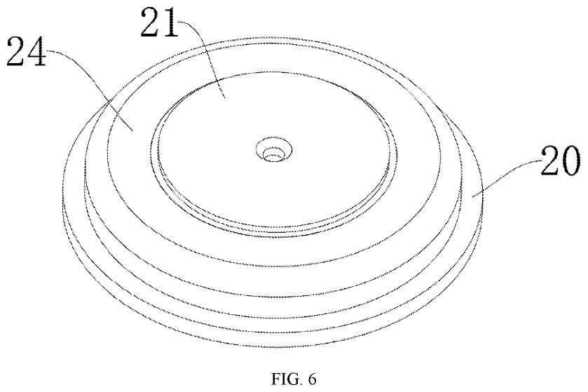

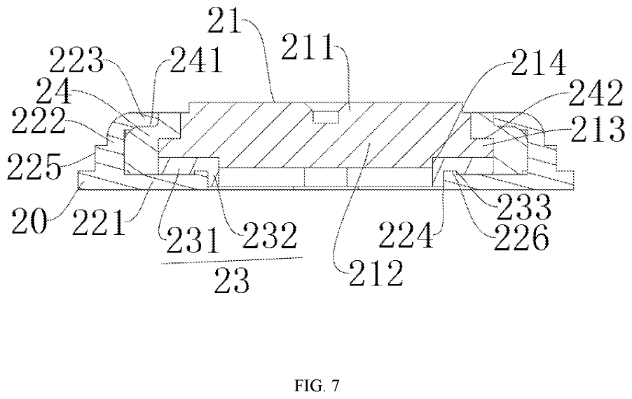

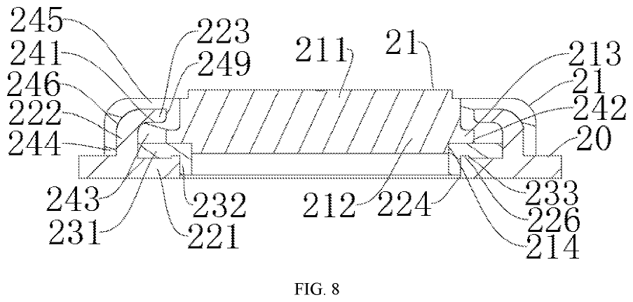

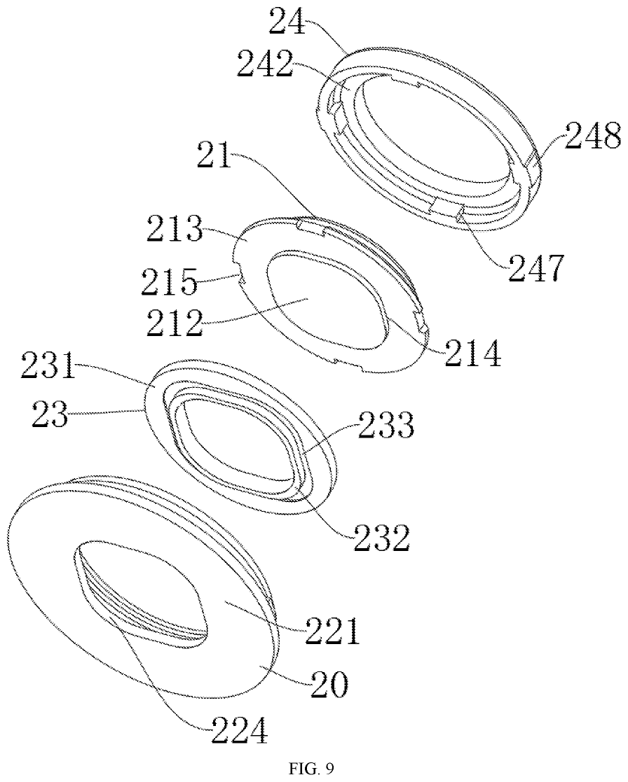

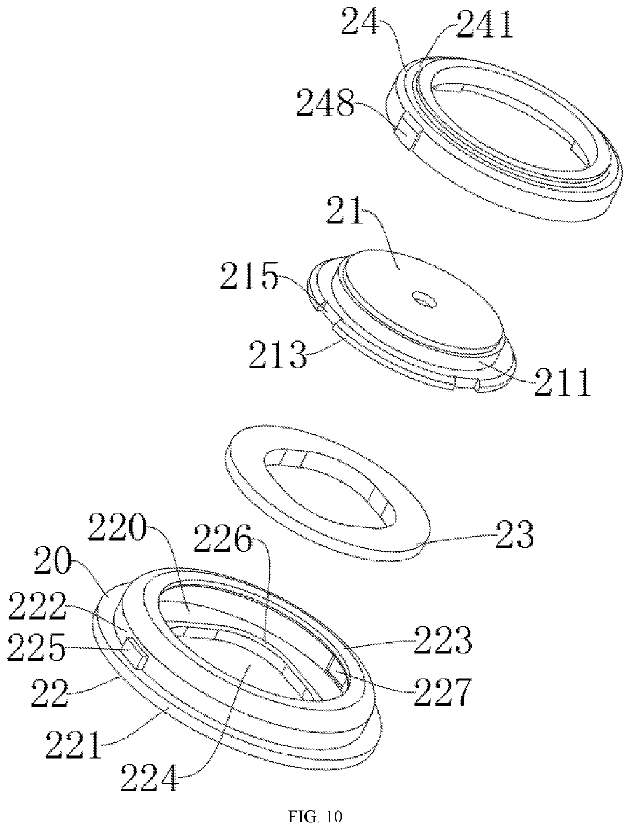

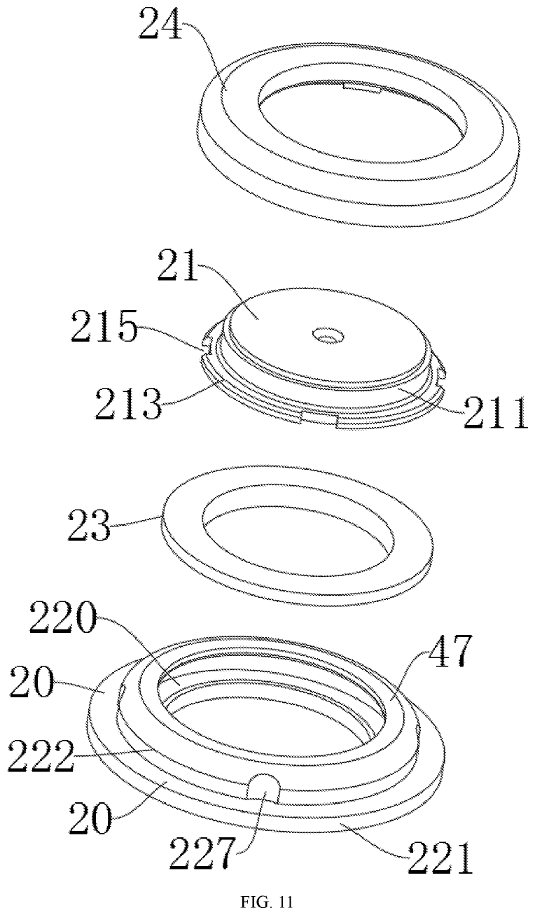

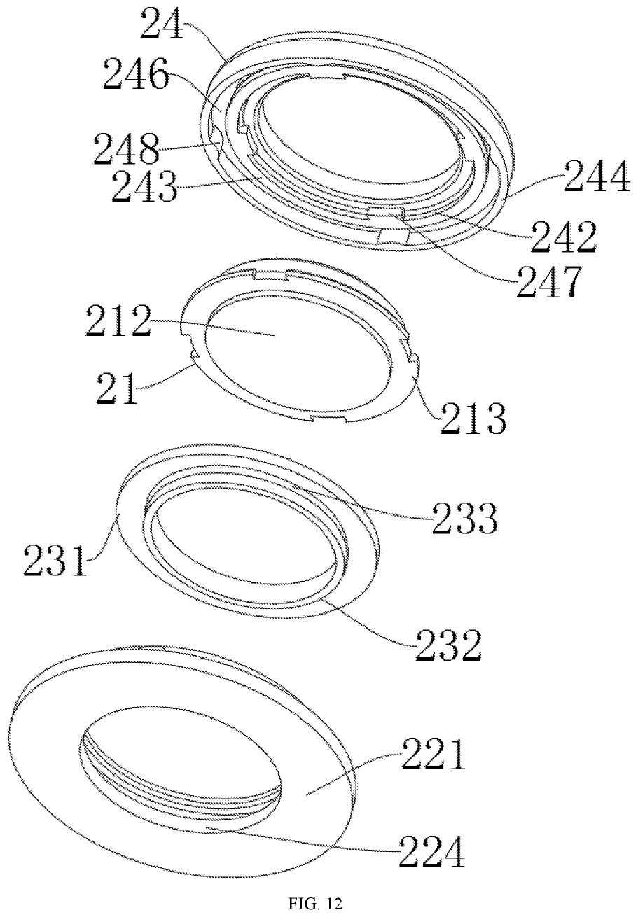

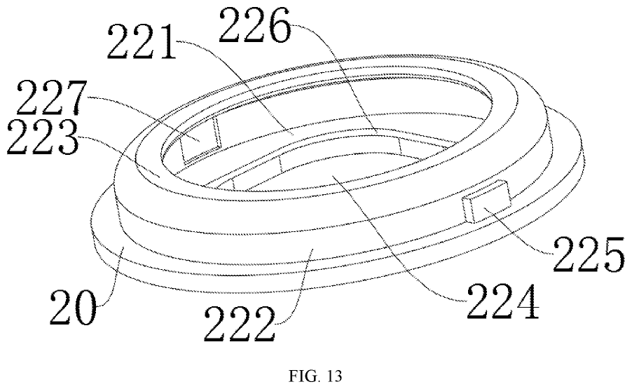

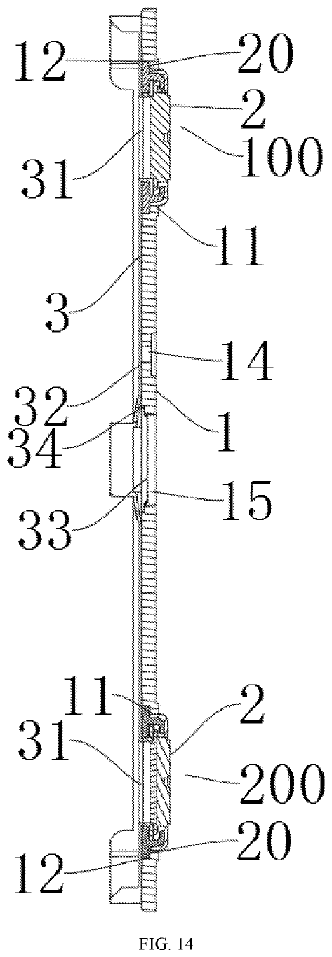

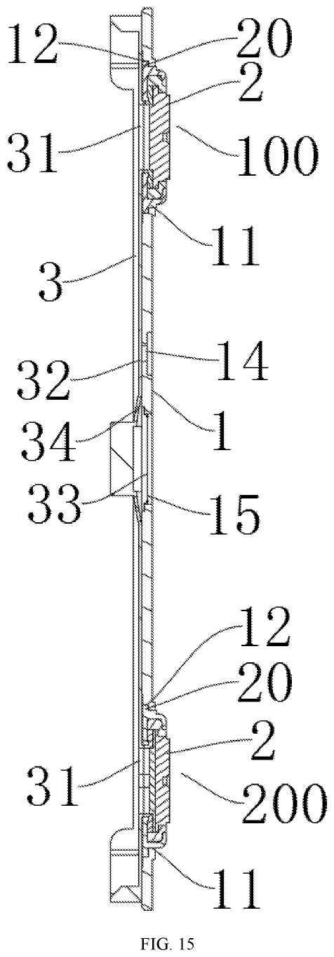

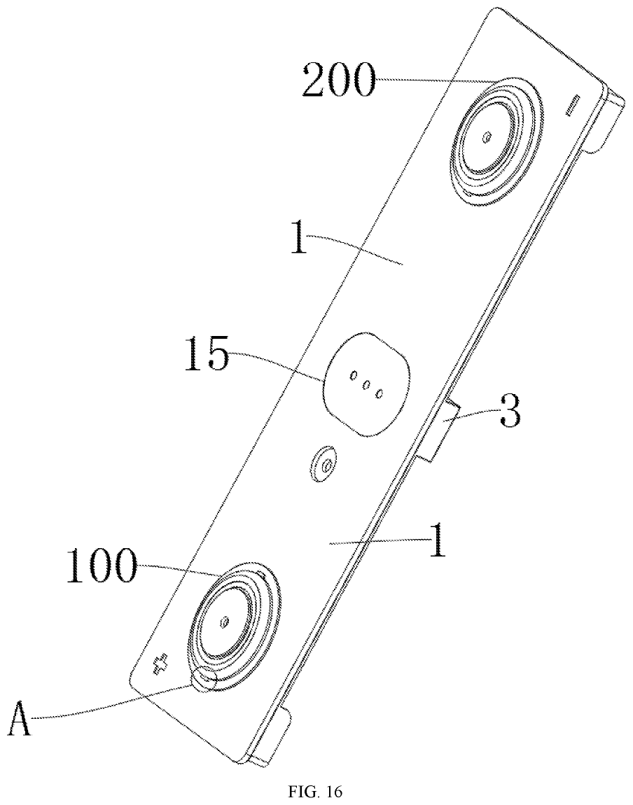

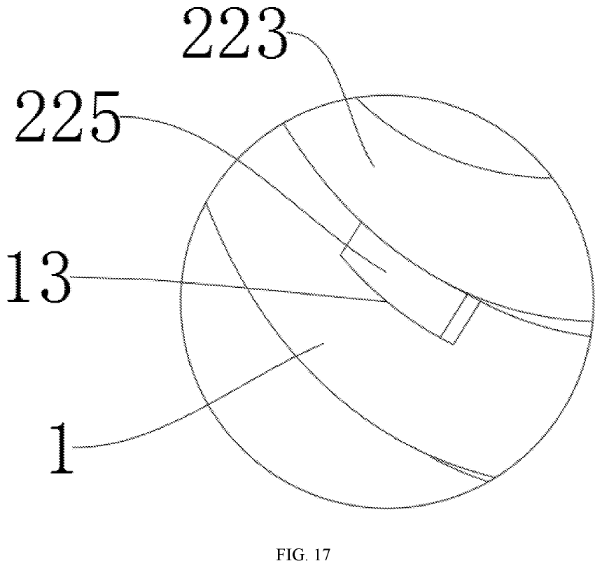

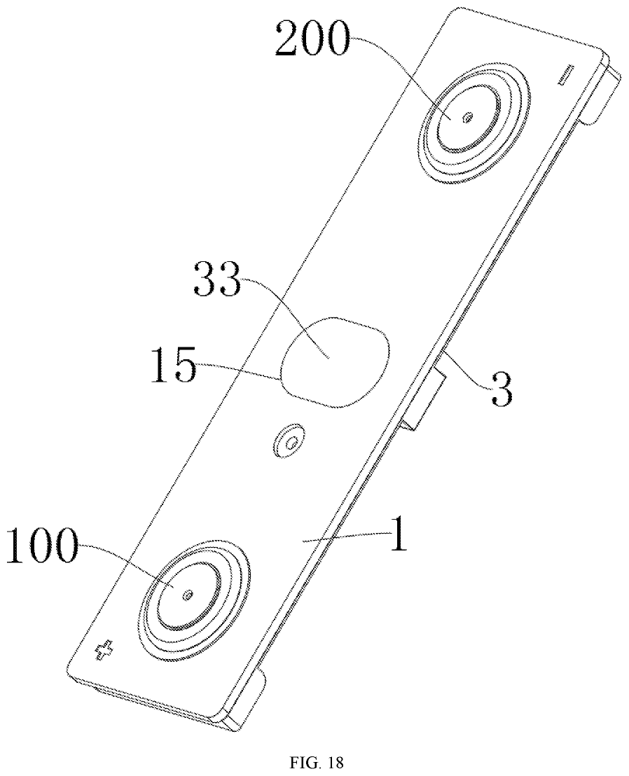

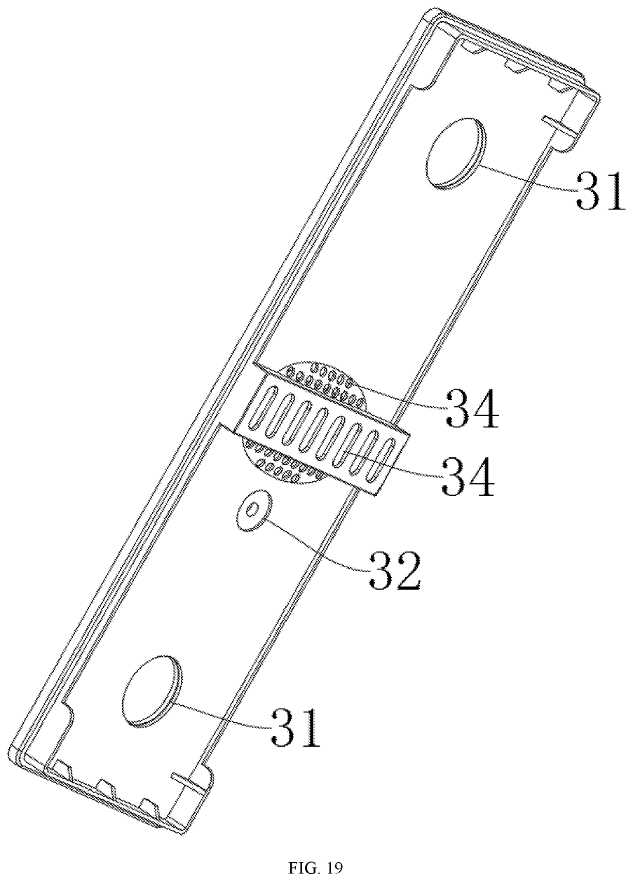

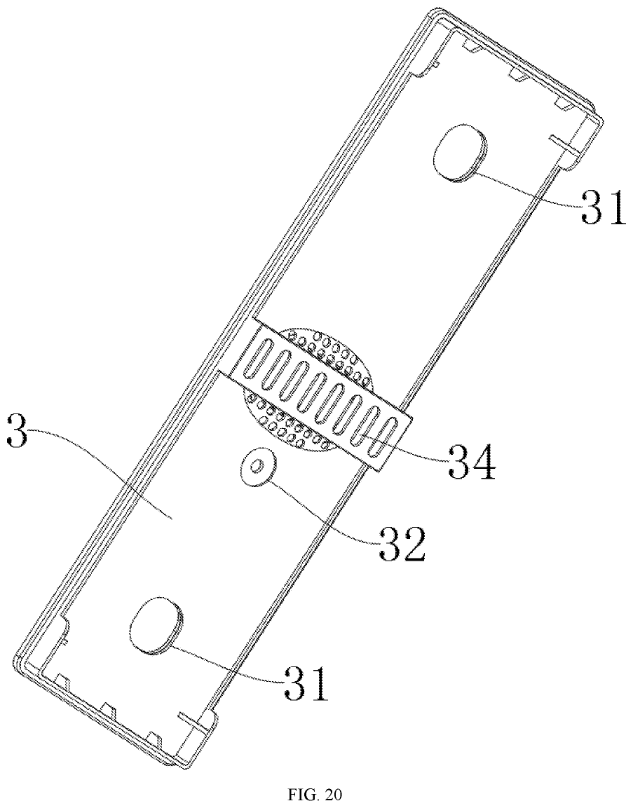

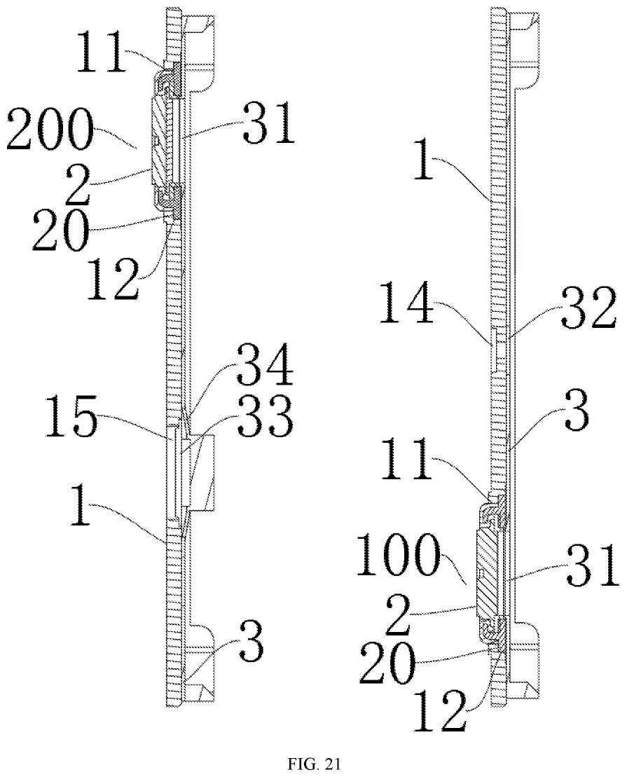

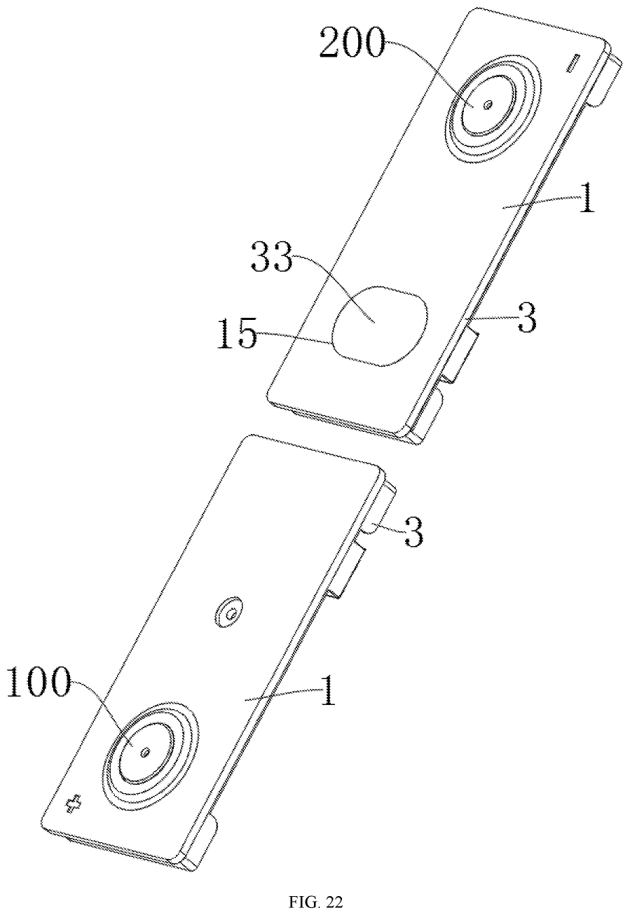

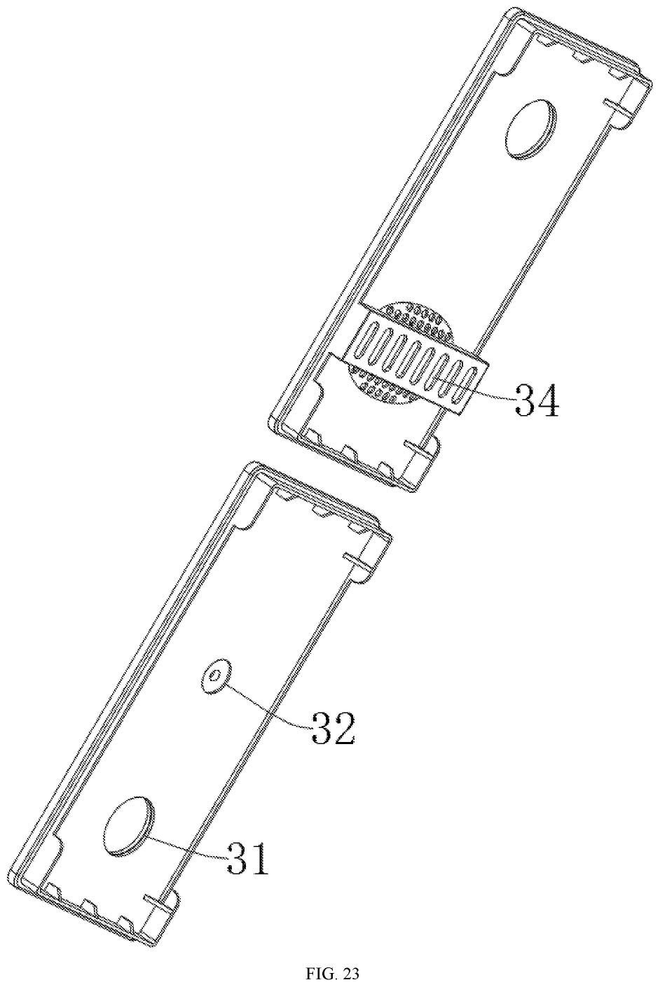

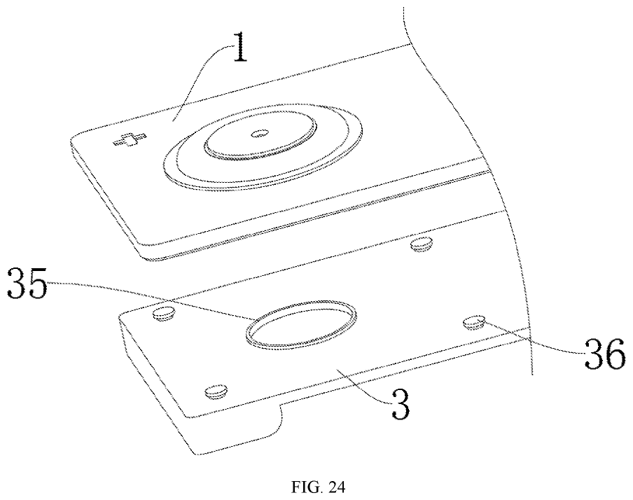

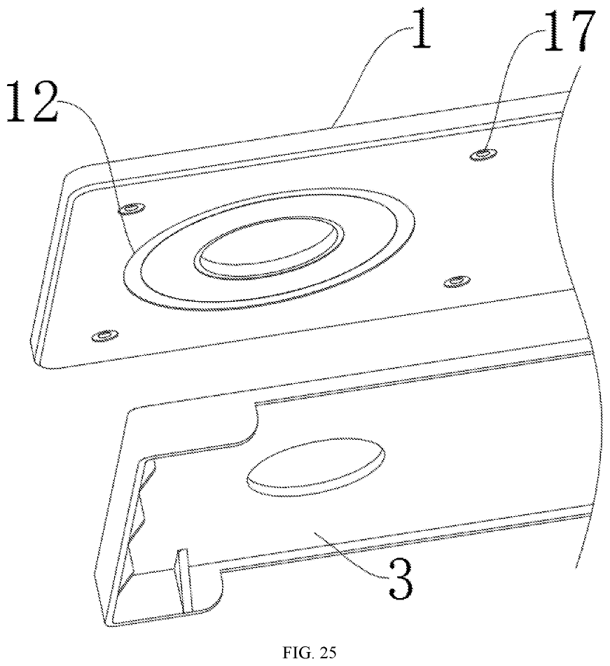

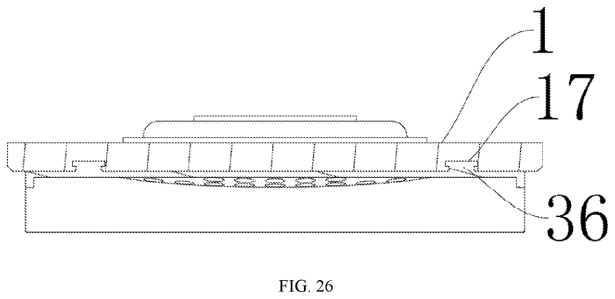

As shown in FIGS. 1-26, the power battery top cover structure described in the present embodiment comprises a top cover plate 1, and two terminal mounting positions on a same top cover plate 1 are respectively fitted with a positive electrode assembly 100 and a negative electrode assembly 200 to form an integral power battery top cover structure, or two terminal mounting positions on different top cover plates 1 are respectively fitted with the positive electrode assembly 100 and the negative electrode assembly 200 to form a split power battery top cover structure; the positive electrode assembly 100 or the negative electrode assembly 200 comprises a conductive terminal structure 2, and the terminal mounting position comprises an assembly hole 11 and connecting grooves 12 arranged continuously or at intervals; the assembly hole 11 is arranged on the top cover plate 1 in a penetrating manner, and the connecting grooves 12 are formed by recessing a portion of the top cover plate 1 located at a bottom surface of the assembly hole 11 inwards, the connecting grooves 12 are formed at an edge of a lower port of the assembly hole 11, and the connecting grooves are arranged in communication with the assembly hole; and the connecting grooves 12 are generally continuous annular grooves or a plurality of grooves arranged in an annular array to form the connecting grooves 12 arranged at intervals.

Connecting portions 20 arranged continuously or at intervals are formed on a bottom peripheral wall of the conductive terminal structure 2, and the connecting portions 20 are in a protruding state on the bottom peripheral wall of the conductive terminal structure 2; and the connecting portions 20 are generally continuous annular bumps or a plurality of bumps arranged in an annular array to form the connecting portions 20 arranged at intervals.

The conductive terminal structure 2 moves from bottom to top under the assembly hole 11 so that a terminal body is assembled into the assembly hole 11, the connecting portions 20 are positioned in the connecting grooves 12, and an outer peripheral wall of the terminal body of the conductive terminal structure 2 is arranged in contact with an inner peripheral wall of the assembly hole 11, and outer walls of the connecting portions 20 are in contact with and welded by laser welding with inner walls of the connecting grooves 12, so that the conductive terminal structure 2 is fixedly connected to the top cover plate 1; when the connecting portions 20 and the connecting grooves 12 are both continuous structures, the annular bumps match the annular grooves, or when the connecting portions 20 and the connecting grooves 12 are both spaced structures, each bump is fitted in a plurality of grooves so as to prevent axial up-down play of the conductive terminal structure 2 after the conductive terminal structure 2 and the assembly hole 11 are fixed by welding. The top cover plate 1 is an aluminum top cover plate 1, and generally the assembly hole 11, the connecting groove 12 in the annular structure, the connecting portions 20 in the annular structure and the terminal body of the conductive terminal structure 2 can be square or circular shape.

In the present embodiment, the conductive terminal structure 2 comprises a terminal fixture 22, a terminal 21, a sealing ring 23 and an insulator 24; the terminal fixture 22 comprises a ring bottom 221 and a ring wall 222 formed on a top surface of the ring bottom 221; a terminal fixing cavity 220 in communication with a positioning hole 224 on the ring bottom 221 is formed between the top surface of the ring bottom 221 and the ring wall 222, and a position between an outer peripheral wall of the ring wall 222 and an outer peripheral wall of the ring bottom 221 forms the connecting portions 20; both the terminal 21 and the sealing ring 23 are placed in the terminal fixing cavity 220; a terminal fixing portion 212 of the terminal 21 is positioned in an inner hole of the sealing ring 23, and an outer peripheral wall of the terminal fixing portion 212 of the terminal 21 is arranged in contact with an inner peripheral wall of the sealing ring 23, so that the terminal fixing portion 212 can be reliably positioned in the terminal fixing cavity 220 before performing injection molding on the ring wall 222 and the terminal 21 or riveting a top of the ring wall 222; the sealing ring 23 is located between the terminal fixing portion 212 of the terminal 21 and an inner bottom surface of the terminal fixing cavity 220; the insulator 24 is arranged to at least partially cover the terminal 21 and is at least partially located between an outer peripheral wall of a terminal portion 211 of the terminal 21 and an inner peripheral wall of the ring wall 222; and the insulator 24 and the terminal fixing portion 212 of the terminal 21 are arranged in concave-convex fit, an inner peripheral wall of the terminal fixing cavity 220 and an outer peripheral wall of the insulator 24 are arranged in concave-convex fit, and a first restricting portion on the ring wall 222 is in fit with a second restricting portion on the insulator 24, so that the insulator 24, the sealing ring 23 and the terminal 21 are all fixedly connected in the terminal fixing cavity 220, and a top surface of the terminal portion 211 of the terminal 21 is higher than a top surface of the top cover plate 1 and is exposed to the outside. The insulator 24 is made of a plastic material, and is made of a PPS material, and the insulator 24 is arranged to only cover the terminal portion 211 of the terminal 21 or arranged to cover both the terminal portion 211 of the terminal 21 and the ring wall 222; and the terminal 21 in the positive electrode assembly 100 is made of an aluminum material, and the terminal 21 in the negative electrode assembly 200 is made of a copper-aluminum alloy material, and the terminal portion 211 of the terminal 21 is a cylindrical structure.

Further, a concave cavity 242 is formed on an inner wall of the insulator 24, convex portions 213 arranged continuously or at intervals are formed on the terminal fixing portion 212 of the terminal 21 along a circumference of the outer peripheral wall of the terminal fixing portion, the convex portions 213 are embedded in the concave cavity 242 for fixing, and the convex portions 213 are in fit with the sealing ring 23 to axially limit the terminal 21 and prevent axial up-down play of the terminal 21. Positioning convexes 247 are formed on an inner wall of the concave cavity 242, positioning concaves 215 are formed on the convex portions 213, and the positioning convexes 247 are correspondingly embedded in the positioning concaves 215, so that the terminal 21 is radially limited in the terminal fixing cavity 220, so that a torque between the terminal 21 and the insulator 24 increases, and relative rotation between the terminal 21 and the insulator 24 is further prevented. The continuous convex portions 213 are convex portions 213 in an annular structure, or the convex portions 213 arranged at intervals are a plurality of convex portions 213 arranged in an annular array on the outer peripheral wall of the terminal fixing portion 212 of the terminal 21.

Still further, a stepped surface 241 is formed on the insulator 24, the stepped surface 241 is the first restricting portion, and a riveting body 223 is formed on a top of the insulator 24, and the riveting body 223 is pressed on the stepped surface 241 of the insulator 24, so that the terminal 21 and the sealing ring 23 are fixedly connected in the terminal fixing cavity 220 of the terminal fixture 22; and the riveting body 223 is the second restricting portion, and an outer peripheral wall of the terminal fixture 22 is arranged in contact with the inner peripheral wall of the assembly hole 11, and the insulator 24 is at least partially located between the sealing ring 23 and the riveting body 223; and the riveting body 223 is in fit with the stepped surface 241, and the convex portions 213 are in fit with the concave cavity 242, which prevent the terminal 21 from being dislodged from the terminal fixing cavity 220, so that the terminal 21 is stably fixed in the terminal fixing cavity 220.

In the present embodiment, the sealing ring 23 comprises a sealing ring sheet 231 and a sealing ring body 232 formed on a bottom surface of the sealing ring sheet 231; an outer wall of the sealing ring body 232 is in contact with an inner wall of the positioning hole 224 on the ring bottom 221; the sealing ring sheet 231 is located between the convex portions 213 and the ring bottom 221 in a compressed state; a convex ring 226 is formed on the top surface of the ring bottom 221, a ring groove 233 is formed on the bottom surface of the sealing ring sheet 231, and the convex ring 226 is embedded in the ring groove 233; the terminal fixing portion 212 of the terminal 21 is positioned in an inner hole of the sealing ring sheet 231, and the outer peripheral wall of the terminal fixing portion 212 of the terminal 21 is arranged in contact with an inner hole wall of the sealing ring sheet 231, so that the terminal fixing portion 212 of the terminal 21 and the ring bottom 221 are sealed; the convex ring 226 is embedded in the ring groove 233, so that the sealing ring sheet 231 is limited on the ring bottom 221, and performance of sealing between the sealing ring sheet 231 and the ring bottom 221 is improved; the sealing ring body 232 is arranged, so that the sealing ring 23 is positioned and mounted through the positioning hole 224 on the ring bottom 221 before injection molding, which prevents displacement and improves structural stability of the terminal structure; the sealing ring 23 is made of a fluororubber material; an annular recess 214 is formed on the terminal fixing portion 212 of the terminal 21, and an upper inner wall of the annular recess 214 is arranged flush with bottom surfaces of the convex portions 213, so that the sealing ring sheet 231 is at least partially placed in the annular recess 214; a top surface of the sealing ring 23 is arranged in close contact with the bottom surfaces of the convex portions 213 and the upper inner wall of the annular recess 214, so that the terminal 21 is reliably positioned before injection molding on the ring wall 222 and the terminal 21 or riveting the top of the ring wall 222; and a portion of terminal fixing portion 212 positioned in the sealing ring 23 can be circular or square shape, when such portion is circular shape, correspondingly the positioning hole 224 on the ring bottom 221, the convex ring 226, the ring groove 233 and the sealing ring body 232 are all arranged in circular shape, and when such portion is square shape, correspondingly the positioning hole 224 on the ring bottom 221, the convex ring 226, the ring groove 233 and the sealing ring body 232 are all arranged in square shape.

In the present embodiment, the power battery top cover structure further comprises a lower plastic part 3 fixed on a bottom surface of the top cover plate 1. Specifically, a plurality of T-shaped bosses 36 are formed on a top surface of the lower plastic part 3, a plurality of T-shaped grooves 17 are formed on the bottom surface of the top cover plate 1, and the T-shaped bosses 36 are molded on the T-shaped grooves 17 by heat fusion, so that the lower plastic part 3 is fixed on the bottom surface of the top cover plate 1; the top cover plate 1 is provided with an electrolyte injection port 14 and an explosion-proof valve 33; a through hole 31 positionally corresponding to the positioning hole 224 on the ring bottom 221, an electrolyte injection hole 32 positionally corresponding to the electrolyte injection port 14 and a vent hole 34 positionally corresponding to the explosion-proof valve 33 are formed on the lower plastic part 3; an annular convex 35 is formed by extending an upper port edge of the through hole 31 upwards, and the annular convex 35 is placed in the positioning hole 224 on the ring bottom 221; and the lower plastic part 3 is made of a PPS material, the explosion-proof valve 33 is composed of a diaphragm and a rupture disc with an annular indentation or a C-shaped indentation, the diaphragm and the rupture disc are welded and fixed in an explosion-proof hole 15 of the top cover plate 1, and the diaphragm is located above the rupture disc.

When the insulator 24 is arranged to only cover the terminal portion 211 of the terminal 21, the insulator 24 is preformed, or the insulator 24 is formed by performing injection molding and encapsulation treatment on the terminal 21, and limiting portions 248 are convexly formed on the outer peripheral wall of the insulator 24; the terminal 21 and the insulator 24 are combined to form an independent terminal assembly; after the terminal assembly is assembled into the terminal fixing cavity 220, a pressure is applied to the terminal 21, so that the top of the ring wall 222 is bent toward the terminal 21 when the sealing ring 23 is in a compressed state to form the riveting body 223, and the riveting body 223 is at least partially located above the convex portions 213; the riveting body 223 is formed by riveting the top of the ring wall 222 by a riveting apparatus, and the riveting body 223 is pressed on the stepped surface 241 of the insulator 24, so that the terminal 21 and the sealing ring 23 are fixedly connected in the terminal fixing cavity 220 of the terminal fixture 22; the outer peripheral wall of the terminal fixture 22 is arranged in contact with the inner peripheral wall of the assembly hole 11, so that after the terminal structure is reliably positioned in the assembly hole 11, it is convenient to perform the next welding between a assembly hole 11 and a connecting portion 20 to form a riveted terminal, and after the terminal 21 of the riveted terminal is fixedly connected to the terminal fixture 22, the sealing ring 23 can reach 30% compression, thereby meeting the airtightness requirements; the top surface of the terminal portion 211 of the terminal 21 is higher than a top surface of the insulator 24, so that the top surface of the terminal portion 211 of the terminal 21 is exposed; and in the formed conductive terminal structure 2, a portion of the terminal fixing portion 212 positioned in the sealing ring 23 is preferably square shape, correspondingly the positioning hole 224 on the ring bottom 221, the convex ring 226, the ring groove 233 and the sealing ring body 232 are all circular shape, and the top surface of the terminal portion 211 of the terminal 21 is higher than a top surface of the riveting body 223.

In order to radially limit the insulator 24 and the terminal fixture 22, the inner peripheral wall of the ring wall 222 is recessed to form a limiting groove 227, and the limiting portions 248 are fitted in the limiting grooves 227, and there may be one or more limiting grooves 227 and limiting portions 248, and two opposite inner walls of the limiting groove 227 are respectively in contact with two opposite inner walls of the limiting portion 248, so as to realize radial limiting between the insulator 24 and the terminal fixture 22, and the limiting portion 248 is in a protruding state.

Preferably, a plurality of recesses are formed on an inner wall of the terminal fixing cavity 220, a plurality of protrusions are formed on an outer wall of the insulator 24, and the protrusions are correspondingly embedded in the recesses, this configuration radially limits the insulator 24 and the terminal fixing cavity 220 to prevent relative rotation between the insulator 24 and the terminal fixture 22, thereby increasing the torque. Generally, the protrusions are formed on a bottom surface of the insulator 24 in a protruding manner, and the recesses is formed by recessing an inner bottom surface of the terminal fixing cavity 220.

Preferably, a plurality of flanges 225 are formed on the outer peripheral wall of the ring wall 222, a plurality of depressions 13 are formed on the inner peripheral wall of the assembly hole 11, and the flanges 225 are embedded in the depressions 13, which improves radial limiting of the conductive terminal structure 2 in the assembly hole 11 after mounting, and prevents relative rotation between the conductive terminal structure 2 and the assembly hole 11, so as to achieve clamping between the conductive terminal structure 2 and the assembly hole 11.

When the insulator 24 is injection molded and covers both the ring wall 222 and the terminal portion 211 of the terminal 21, a plurality of limiting grooves 227 are formed on the ring wall 222; the terminal 21 and the sealing ring 23 are placed in the terminal fixing cavity 220, and the riveting body 223 is at least partially located above the convex portions 213; then the terminal fixture 22 is placed in an injection molding apparatus, and a pressure is applied to the terminal 21, so that the insulator 24 is injection molded when the sealing ring 23 is in a compressed state; the insulator 24 comprises a terminal covering portion 243, a ring wall covering portion 244, a riveting body covering portion 245 and the limiting portions 248 fitted in the limiting grooves 227; a locking cavity 246 is formed among an outer wall of the terminal covering portion 243, an inner wall of the ring wall covering portion 244 and an inner wall of the riveting body covering portion 245; the outer wall of the terminal covering portion 243 is recessed to form a fixing concave 249; an inner bottom surface of the fixing concave 249 is used as the stepped surface 241, and the ring wall 222 and the riveting body 223 are embedded in the locking cavity 246; the riveting body 223 is embedded in the fixing concave 249, so that the terminal covering portion 243 is located between the terminal 21 and the inner peripheral wall of the ring wall 222; the ring wall covering portion 244 is covered on the outer peripheral wall of the ring wall 222, and the terminal portion 211 of the terminal 21 is at least partially covered by an inner peripheral wall of the terminal covering portion 243, and an outer peripheral wall of the ring wall covering portion 244 is arranged in contact with the inner peripheral wall of the assembly hole 11, and the limiting portions 248 are formed on the inner wall of the ring wall covering portion 244, and the concave cavity 242 is formed on the inner peripheral wall of the terminal covering portion 243, which forms an injection molded terminal, and after the terminal 21 of the injection molded terminal is fixedly connected to the terminal fixture 22, the sealing ring 23 can reach 30% compression, thereby meeting the airtightness requirements; and the terminal covering portion 243, the ring wall covering portion 244, the riveting body covering portion 245 and the limiting portions 248 are combined to form an integral insulator 24, and the limiting portions 248 are in fit with the limiting grooves 227 to radially limit the insulator 24 and the terminal fixture 22, so that the torque between the insulator 24 and the terminal fixture 22 increases. The sealing ring sheet 231 is located between the terminal covering portion 243 and the ring bottom 221, or a bottom surface of the terminal covering portion 243 is completely or at least partially in contact with the ring bottom 221, and after contact with the ring bottom 221, protrusions are formed by protruding a bottom surface of the terminal covering portion 243, recesses are formed by recessing the inner bottom surface of the terminal fixing cavity 220, and the protrusions are fitted in the recesses.

In the formed conductive terminal structure 2 described above, the portion of the terminal fixing portion 212 positioned in the sealing ring 23 can be selected to be circular or square shape according to actual situation, the top surface of the terminal portion 211 of the terminal is higher than a top surface of the riveting body covering portion 245, and the limiting portion 248 is in a protruding state.

What is claimed is:

1. A power battery top cover structure, comprising a top cover plate and a conductive terminal structure, and the conductive terminal structure being fitted in a terminal mounting position on the top cover plate;
wherein the terminal mounting position comprises an assembly hole and connecting grooves arranged continuously or at intervals, the assembly hole is arranged on the top cover plate in a penetrating manner, and the connecting grooves are formed by recessing a portion of the top cover plate located at a bottom surface of the assembly hole inwards, the connecting grooves are formed at an edge of a lower port of the assembly hole, and the connecting grooves are arranged in communication with the assembly hole;
connecting portions arranged continuously or at intervals are formed on a bottom peripheral wall of the conductive terminal structure, and the connecting portions are in a protruding state on the bottom peripheral wall of the conductive terminal structure; and
the conductive terminal structure moves from bottom to top under the assembly hole so that a terminal body is assembled into the assembly hole, the connecting portions are positioned in the connecting grooves, and an outer peripheral wall of the terminal body of the conductive terminal structure is arranged in contact with an inner peripheral wall of the assembly hole, and outer walls of the connecting portions are in contact with and welded with inner walls of the connecting grooves, so that the conductive terminal structure is fixedly connected to the top cover plate.

2. The power battery top cover structure according to claim 1, wherein the conductive terminal structure comprises a terminal fixture, a terminal, a sealing ring and an insulator; the terminal fixture comprises a ring bottom and a ring wall formed on a top surface of the ring bottom; a terminal fixing cavity in communication with a positioning hole on the ring bottom is formed between the top surface of the ring bottom and the ring wall, and a position between an outer peripheral wall of the ring wall and an outer peripheral wall of the ring bottom forms the connecting portions; both the terminal and the sealing ring are placed in the terminal fixing cavity; a terminal fixing portion of the terminal is positioned in an inner hole of the sealing ring, an outer peripheral wall of the terminal fixing portion of the terminal is arranged in contact with an inner peripheral wall of the sealing ring, and the sealing ring is located between the terminal fixing portion of the terminal and an inner bottom surface of the terminal fixing cavity; the insulator is arranged to at least partially cover the terminal and is at least partially located between an outer peripheral wall of a terminal portion of the terminal and an inner peripheral wall of the ring wall; and the insulator and the terminal fixing portion of the terminal are arranged in concave-convex fit, an inner peripheral wall of the terminal fixing cavity and an outer peripheral wall of the insulator are arranged in concave-convex fit, and a first restricting portion on the ring wall is in fit with a second restricting portion on the insulator, so that the insulator, the sealing ring and the terminal are all fixedly connected in the terminal fixing cavity, and a top surface of the terminal portion of the terminal is higher than a top surface of the top cover plate and is exposed to the outside.

3. The power battery top cover structure according to claim 2, wherein a concave cavity is formed on an inner wall of the insulator, convex portions arranged continuously or at intervals are formed on the terminal fixing portion of the terminal along a circumference of the outer peripheral wall of the terminal fixing portion, the convex portions are embedded in the concave cavity, positioning convexes are formed on an inner wall of the concave cavity, positioning concaves are formed on the convex portions, and the positioning convexes are correspondingly embedded in the positioning concaves.

4. The power battery top cover structure according to claim 3, wherein a stepped surface is formed on the insulator, the stepped surface is the first restricting portion, and a riveting body is formed on a top of the insulator, and the riveting body is pressed on the stepped surface of the insulator, so that the terminal and the sealing ring are fixedly connected in the terminal fixing cavity of the terminal fixture; and the riveting body is the second restricting portion, and an outer peripheral wall of the terminal fixture is arranged in contact with the inner peripheral wall of the assembly hole.

5. The power battery top cover structure according to claim 4, wherein the sealing ring comprises a sealing ring sheet and a sealing ring body formed on a bottom surface of the sealing ring sheet; an outer wall of the sealing ring body is in contact with an inner wall of the positioning hole on the ring bottom; the sealing ring sheet is located between the convex portions and the ring bottom in a compressed state, a convex ring is formed on the top surface of the ring bottom, a ring groove is formed on the bottom surface of the sealing ring sheet, and the convex ring is embedded in the ring groove; and the terminal fixing portion of the terminal is positioned in an inner hole of the sealing ring sheet, and the outer peripheral wall of the terminal fixing portion of the terminal is arranged in contact with an inner hole wall of the sealing ring sheet, so that the terminal fixing portion of the terminal and the ring bottom are sealed.

6. The power battery top cover structure according to claim 5, further comprising a lower plastic part, wherein the lower plastic part is fixed on a bottom surface of the top cover plate, and the top cover plate is provided with an electrolyte injection port and an explosion-proof valve; a through hole positionally corresponding to the positioning hole on the ring bottom, an electrolyte injection hole positionally corresponding to the electrolyte injection port and a vent hole positionally corresponding to the explosion-proof valve are formed on the lower plastic part; and an annular convex is formed by extending an upper port edge of the through hole upwards, and the annular convex is placed in the positioning hole on the ring bottom.

7. The power battery top cover structure according to claim 6, wherein the insulator is preformed, or the insulator is formed by performing injection molding and encapsulation treatment on the terminal, and limiting portions are convexly formed on the outer peripheral wall of the insulator; a pressure is applied to the terminal, so that the ring wall is bent toward the terminal when the ring wall is in a compressed state to form the riveting body, and the riveting body is at least partially located above the convex portions; and the inner peripheral wall of the ring wall is recessed to form limiting grooves, and the limiting portions are fitted in the limiting grooves to radially limit the insulator and the terminal fixture.

8. The power battery top cover structure according to claim 6, wherein a plurality of limiting grooves are formed on the ring wall; a pressure is applied to the terminal, so that the insulator is injection molded when the sealing ring is in the compressed state; the insulator comprises a terminal covering portion, a ring wall covering portion, a riveting body covering portion and the limiting portions fitted in the limiting grooves; a locking cavity is formed among an outer wall of the terminal covering portion, an inner wall of the ring wall covering portion and an inner wall of the riveting body covering portion; the outer wall of the terminal covering portion is recessed to form a fixing concave; an inner bottom surface of the fixing concave is used as the stepped surface, and the ring wall and the riveting body are embedded in the locking cavity; the riveting body is embedded in the fixing concave, so that the terminal covering portion is located between the terminal and the inner peripheral wall of the ring wall; the ring wall covering portion is covered on the outer peripheral wall of the ring wall, and the terminal portion of the terminal is at least partially covered by an inner peripheral wall of the terminal covering portion, and an outer peripheral wall of the ring wall covering portion is arranged in contact with the inner peripheral wall of the assembly hole; and the limiting portions are formed on the inner wall of the ring wall covering portion, and the concave cavity is formed on the inner peripheral wall of the terminal covering portion; and the terminal covering portion, the ring wall covering portion, the riveting body covering portion and the limiting portions are combined to form an integral insulator.

9. The power battery top cover structure according to claim 7, wherein a plurality of recesses are formed on an inner wall of the terminal fixing cavity, a plurality of protrusions are formed on an outer wall of the insulator, and the protrusions are correspondingly embedded in the recesses.

10. The power battery top cover structure according to claim 7, wherein a plurality of flanges are formed on the outer peripheral wall of the ring wall, a plurality of depressions are formed on the inner peripheral wall of the assembly hole, and the flanges are embedded in the depressions.
